(19) United States
(12) Patent Application Publication
(10) Pub. No.: US 2016/0263945 A1
(43) Pub. Date: Sep. 15, 2016

(54) Tire

(71) Applicants: COMPAGNIE GENERALE DES ETA- BLISSEMENTS MICHELIN, Clermont-Ferrand (FR); MICHELIN RECHERCHE ET TECHNIQUE S.A, Granges-Paccot (CH)

(72) Inventor: David Dean, Clermont-Ferrand Cedex 9 (FR)

(21) Appl. No.: 15/034,134

(22) PCT Filed: Nov. 18, 2014
(86) PCT No.: PCT/EP2014/074928

§ 371 Date: May 3, 2016

(30) Foreign Application Priority Data
Nov. 20, 2013 (FR) 1361403

(51) Int. Cl. B60C 11/03; B60C 9/18; B60C 11/00; B60C 9/02

(52) U.S. Cl. CPC B60C 11/033; B60C 9/02; B60C 9/18; B60C 11/0083; B60C 2011/0353; B60C 2011/0358; B60C 2011/0344

(57) ABSTRACT

A tire tread comprises transverse incisions (9) and circumferential incisions (3a, 3b, 3c) opening onto the tread surface, each incision having a mean radial depth E. The circumferential incisions have at the tread shoulder a mean circumferential radius of curvature R_{c}, a linear void ratio T_{c}, and an axial width L_{c}, and are spaced by length P from radial axis ZZ′ passing through the tire centre. The transverse incisions have at the tire shoulder a mean transverse radius of curvature Rₜ, a linear void ratio Tₜ, and an axial width Lₜ. The linear void ratio T_{c} is greater than or equal to 0.8E/Rₜ and less than or equal to 1.2E/Rₜ, the linear void ratio Tₜ is greater than or equal to 0.8E/R_{c} and less than or equal to 1.2E/R_{c}, T_{c}>Tₜ, and L_{c} is greater than or equal to 0.2 mm and less than or equal to 1.5 mm.

The invention relates to a tire, preferably for a passenger vehicle or for a light goods vehicle.

The invention relates to radial tires or cross-ply tires.

Radial tires have gradually been imposed in various markets, notably the passenger vehicle tire market. This success is owed in particular to the endurance, comfort and low rolling resistance qualities of the radial architecture.

The main parts of a tire are the tread, the sidewalls and the beads. The beads are intended to come into contact with the rim. In a radial tire, each of the main parts that make up the tire, namely the tread, the sidewalls and the beads, has functions very distinct from one another and therefore has a well known specific makeup.

A radial tire is essentially reinforced by a carcass reinforcement comprising at least one carcass ply having an angle substantially equal to 90° with respect to the circumferential direction of the tire. This carcass reinforcement is surmounted radially on the outside, and under the tread, with reinforcing plies forming a belt.

A cross-ply tire differs from a radial tire through the presence of at least two crossed carcass plies the angle of which is other than 90° with respect to the circumferential direction of the tire. The plies are said to be “cross” because the angles are of opposite sign from one ply to the other.

It will be recalled that, according to the invention, the circumferential direction of the tire is the direction comprised in a plane perpendicular to the axis of rotation of the tire and tangential to the tire belt reinforcement.

Following the emergence of radial tires, certain cross-ply tires have also been provided with a belt reinforcement under the tread.

In both these two types of tire, the tread, in direct contact with the ground, notably has the function of providing contact with the roadway and needs to conform to the shape of the ground. The sidewalls, for their part, absorb unevenesses of the ground while transmitting the mechanical forces required in order to bear the load of the vehicle and allow it to move.

The belt reinforcement is a reinforcement which needs, on the one hand, to be sufficiently rigid with respect to edge deformations that the tire can develop the cornering thrust needed to steer it, and transmit the driving or braking torque and, on the other hand, be very soft in bending, which means to say allow variations in curvature of its plane in order to provide a sufficient area of contact of the tire with the ground.

As a result, the belt reinforcement generally has a composite structure allowing it to offer the required rigidity for a relatively light weight. The belt reinforcement is generally made up of at least two plies at different angles, containing reinforcers, in the form of cords, coated in rubber. The reinforcing elements are crossed from one ply to the other with respect to the circumferential direction and may or may not be symmetric about this direction.

The following definitions are used here:
“longitudinal direction”: direction of running of the tire,
“radial direction”: direction intersecting the axis of rotation of the tire and perpendicular thereto,
“circumferential direction”: direction corresponding to the periphery of the tire and defined by the direction of the running of the tire,
“radially on the inside of”: means closer to the axis of rotation,
“radially on the outside of”: means further away from the axis of rotation,
“equatorial plane or median plane”: plane perpendicular to the axis of rotation of the tire and which divides the tire into two substantially equal halves,
“axial or transverse direction of the tire”: direction parallel to the axis of rotation,
“radial or meridian plane”: a plane containing the axis of rotation of the tire.

Document EP 0787601 A1 already discloses a tire tread notably comprising several incisions of transverse or circumferential overall orientation which respectively define a mean circumferential void ratio and a mean transverse void ratio.

Document GB 518 601 describes a tire comprising various circumferential and transverse incisions alternating with blocks of rubber, the circumferential peripheral incisions being very close together.

Document EP 2 230 102 describes a tire comprising two main circumferential incisions arranged in the first quarter of the tread measured from the axial end, and several wide transverse incisions.

The expression circumferential denotes the periphery of the tire and, more particularly, the surface of the tread.

The linear circumferential void ratio is defined in a radial direction and expressed as the ratio of the surface area of the transverse incisions on the tread to the total surface area of the said tread. According to document EP 0787601 A1, this void ratio is chosen so that all the transverse incisions are closed when they fall within the contact patch in which the tire is in contact with the ground.

Even if the void ratio defined in that document already makes it possible to achieve a significant reduction in the rolling resistance, there is still a need to be able to have a tread that allows the tire to maintain this reduction in rolling resistance while at the same time combining same with a significant weight saving, thereby allowing a marked decrease in fuel consumption.

The subject of the invention is therefore a tire having an external perimeter, a tread arranged radially on the outside of a reinforcing belt of the tire, itself on the outside of a carcass reinforcement, the said tread having an axial half-width L, a mean radial depth E, comprising a central median zone and two axially end zones, called shoulders of width L/2 and comprising a tread surface intended to come into contact with the ground, the said tread comprising a plurality of transverse incisions and of circumferential incisions opening onto the surface of the tread, each circumferential and transverse incision having a mean radial depth E,
at least one circumferential incision having at the shoulder:
   a mean circumferential radius of curvature of the shoulder R_{c},
   a linear void ratio T_{c}, and
   an axial width L_{c}, the said circumferential incisions being spaced by a length P from a radial axis ZZ′ passing through the centre of the tire,
transverse incisions having at the shoulder:
   a mean transverse radius of curvature of the shoulder Rₜ,
   a linear void ratio Tₜ, and
   an axial width Lₜ.

The invention is characterized in that the linear void ratio T_{c} is greater than or equal to 0.8 E/Rt and less than or equal to 1.2 E/Rt, in that the linear void ratio Tₜ is greater than or equal to 0.8 E/Rc and less than or equal to 1.2 E/Rc, in that Tc>Tt, and in that Lc is greater than or equal to 0.2 mm and less than or equal to 1.5 mm.

The external perimeter of the tire denotes the total linear length of the tread.

The axial end of the tread is also referred to as the “shoulder”.

The expression “circumferential incisions” means incisions made in the circumferential direction. The expression “transverse incisions” denotes incisions made in the axial direction.

Each radius of curvature R_{c} is measured between the centre of rotation of the tire and the centre of a block of rubber arranged between two successive circumferential incisions.

Each radius of curvature Rt is measured from various successive and mutually tangential curved portions arranged at the surface of the tread.

The tread according to the invention offers the advantage of also guaranteeing the tire good aerodynamic behaviour and grip on a wet road surface and of reducing its rate of wear.

The tire comprising the tread according to the invention has a crown deflection of between 4 and 8%.

It will be recalled that the crown deflection is the ratio H/2 L, where L is the half-width of the tread, the said tread being defined as being the width of the contact patch of the tire mounted, inflated to its nominal pressure, and under load, and H is the radial height of the tread defined at the centre of the tire in the radial direction as far as an axial axis passing through the ends in the longitudinal direction of the contact patch. The more pronounced the rounding of the profile of the tire, the greater the crown deflection.

The somewhat “round”, narrow and highly inflated profile of the tire according to the invention allows ground pressure to be concentrated towards the centre of the contact patch, and thus notably makes it possible to improve grip performance on wet ground.

For preference, T_{c} is greater than or equal to 0.85 E/Rt and less than or equal to 1.15 E/Rt and Tₜ is greater than or equal to 0.85 E/Rc and less than or equal to 1.15 E/Rc.

For preference, Tₜ is greater than or equal to 0.85 E/Rc and less than or equal to 1.15 E/Rc over at least 90% of the radially outer surface of the shoulder, and more preferably over at least 95% of the radially outer surface of the shoulder.

For preference, at least one shoulder comprises two circumferential incisions each having a substantially identical mean width.

For preference, the axially outermost circumferential incision is distant from the median radial axis ZZ′ by the half-width L.

The axially innermost circumferential incision is distant from the median radial axis ZZ′ by a width Pa greater than or equal to 0.6 L and less than or equal to 0.7 L.

When the tread comprises three axially aligned circumferential incisions, the central circumferential incision is preferably distant from the median radial axis ZZ′ by a length P_{b} greater than or equal to 0.75 L and less than or equal to 0.9 L.

For preference, the radial depth in the median central zone is between 5 and 8 mm.

For preference, the width Lt is greater than or equal to 0.2 mm and less than or equal to 4 mm.

For preference, the tire comprises at least one circumferential incision centred on the median radial axis ZZ′.

For preference, the width of the circumferential incision centred on the median radial axis ZZ′ has a width of between 6 and 10 mm.

For preference, in the central median zone, the transverse linear void ratio Tₜ is greater than 0.85 E/R_{c} and less than 1.15 E/R_{c} over at least 90% of the radially outer surface of the said central zone, and more preferably over at least 95% of the radially outer surface of the said central zone.

For preference, the tire is inflated to a nominal pressure in excess of 2.5 bar, preferably to a nominal pressure in excess of 3 bar and lower than 4 bar.

For preference, the mean transverse radius of curvature Rₜ of the shoulder zone is greater than 0.75 L and less than 0.85 L and less than 150 mm, and preferably greater than 0.85 L and less than L and less than 75 mm.

For preference, the tire comprising the tread according to the invention comprises a crown reinforcing ply arranged radially on the outside of the carcass reinforcement or between two successive plies of the reinforcing belt.

The crown reinforcing ply is preferably arranged at an angle of between 65° and 90° with respect to the circumferential direction.

The plies of the reinforcing belt are cross plies and may each have an angle of between 20° and 25° with respect to the circumferential direction.

The tire according to the invention is mounted and inflated on a rim in the conventional way.

The invention will now be described with the aid of the examples and figures which follow and which are given solely by way of illustration and in which:

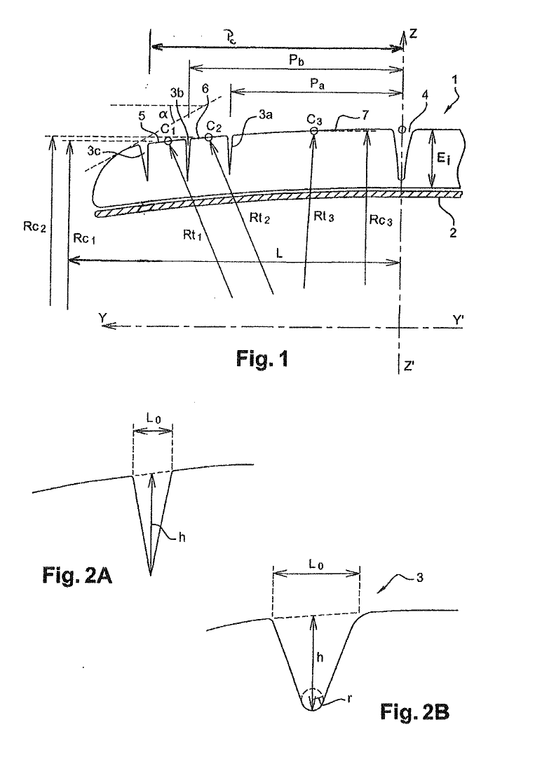

FIG. 1 depicts a meridian section of a radial tire comprising a tread according to the invention,

FIGS. 2A and 2B depict, in cross section, various sections of circumferential incision,

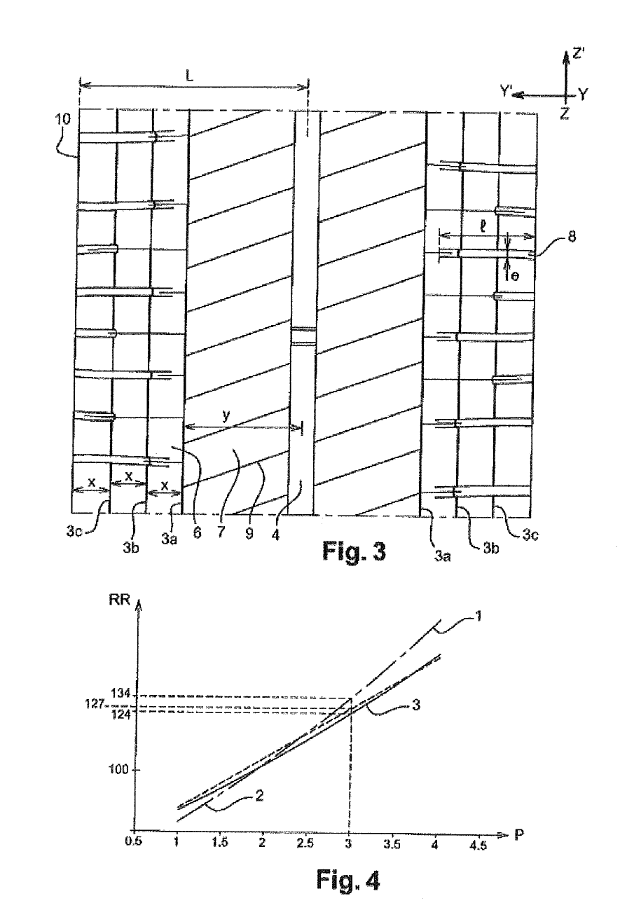

FIG. 3 depicts, viewed from above, a tread pattern of the tread according to the invention,

FIG. 4 depicts various curves of the variation in rolling resistance (RR) as a function of the pressure (in bar) obtained with a control tire, a tire according to document EP 0787601 A1 and a tire according to the invention.

FIG. 1 depicts only half a tread of a tire of size 165/70 R 16 in meridian section, namely in a plane of section containing the axis of rotation of the said tire.

The tread of overall reference 1 is arranged radially on the outside of a reinforcing belt 2. The tread has a half-width L equal to 61.2 mm, and a thickness E equal to 6.5 mm, when new, between the radially external surface and the reinforcing belt 2. The half-width is comprised between a furthest axial end and the median radial axis ZZ′.

The axial end is the point at which the angle α (alpha), between the tangent to the tread surface and an axial direction, is equal to 30°.

The radially outer surface of the tread comprises three circumferential incisions 3a, 3b and 3c spaced apart in the axial direction YY′. The axially innermost incision 3a is spaced from the axis ZZ′ by a length Pₐ equal to 37 mm. The axially outermost incision 3c is spaced away from the radial axis ZZ′ by the length P_{c} equal to L equal to 57 mm. The central incision 3b is spaced from the radial axis ZZ′ by a length P_{b} equal to 47 mm.

The incision 3a has a depth of 6.5 mm and a radius of curvature R^{c1} equal to 316.5 mm; the incision 3b has a depth of 6 mm and a radius of curvature R_{c2} equal to 315.5 mm; and the incision 3c has a depth of 5.8 mm and a radius of curvature R_{c3} equal to 309 mm.

The incisions 3a, 3b and 3c respectively have mean widths of 1 mm, 1 mm and 1.2 mm.

The tread also comprises a median circumferential incision 4 arranged on the axis ZZ′. This incision has a depth equal to 6 mm and a width equal to 8 mm.

These incisions 3a, 3b, 3c and 4 separate the blocks of rubber 5, 6 and 7.

The radially external half-surface of the tread defines the profile of half a tire. This profile is characterized by three successive and mutually tangent curve portions. These curve portions are each defined by a transverse radius of curvature Rₜᵢ and a centre which is dependent on the half-width of the tread L.

The centre of these three curve portions corresponds to the centres c₁, c₂ and c₃ of each of the three blocks of rubber 5, 6 and 7. The transverse radius of curvature of each of these curve portions is, respectively, Rₜ₁ equal to 32 mm, Rₜ₂ equal to 122 mm and Rₜ₃ equal to 350 mm.

The centres c₁, c₂ and c₃ of each curve portion are respectively spaced away from the radial axis ZZ′ by 52 mm, 42 mm and 18.5 mm.

The linear void ratio Eᵢ/Rₜ of the entirety of the circumferential incisions of the half-tread is equal to 8% and is greater than the linear void ratio E/Rₑ equal to 3% of the entirety of the transverse incisions. The result of this is that all the transverse incisions across the entire width of the tread are closed in the contact patch in which the tire makes contact with the ground, both in the shoulder zone and in the central zone.

The linear void ratio of the central zone E/R_{c} is preferably between 2% and 4%.

As FIGS. 2A and 2B show, there may be various geometric shapes of circumferential incision 3.

FIG. 2A shows a substantially V-shaped cross section, of width L₀ corresponding to the width of the circumferential incision measured on the tread surface of the tire when new, in the inflated state, and of depth h greater than the maximum permissible wear height so that it completely closes up in the contact patch whatever the degree of wear of the tread 1. The depth “h” may be between 4 and 8 mm.

FIG. 2B shows an equivalent embodiment in which the radially innermost part of the incision has a substantially rounded shape with radius r equal to 0.25 mm.

FIG. 3 depicts a tread pattern according to the invention for a tire of size 165/70 R 16. This tread pattern comprises circumferential incisions 3a, 3b, 3c at each axial end of the tread, and a circumferential incision 4 at the centre of the tread. Between the incisions 3a; 3b, between 3b; 3c or between 3b and the extreme axial edge of the tread, the block of rubber 6 has a width “x” of around 10 mm Between the incision 3a and the centre of the incision 4, the block of rubber 7 has a width “y” of 37 mm. The tread also comprises transverse incisions 8 arranged radially and having a length “l” equal to 30 mm and a thickness “e” equal to 3 mm Transverse incisions 9 making an angle of 20° with the axial axis YY′. The axial half-width L is depicted between the axial end 10 of the tread and the centre of the incision 4.

In FIG. 4, the curves 1, 2 and 3 are the results of rolling resistance (RR) tests performed respectively using a control tire of reference 205/55 R 16, a tire according to document EP 0787601 A1 of size 165/70 R 16, and a tire comprising the tread according to the invention of size 165/70 R 16, as a function of the pressure P in bar.

These curves were obtained as follows. The tires are mounted on a rim and inflated to 2.9 bar (invention and document EP 0787601 A1) and 2.1 bar (control tire). All the tires bear the same load of 483 daN.

These tires are then mounted on a measurement machine which involves driving the wheel at a given speed, by bringing it into contact with a driving drum.

Once the speed of the wheel has stabilized, the motor is disengaged and the system is allowed to slow of its own accord. The method consists in measuring the deceleration of the system in order from this to deduce the rolling resistance of the tire.

From this figure it may be seen that a tire comprising the tread according to the invention (curve 3) offers a 10% saving in rolling resistance by comparison with the control tire and a saving of 3% with respect to the tire of document EP 0787601 A1.

Moreover, the tread according to the invention allows a tire to offer good performance in terms of measured braking on wet ground, measured wear and measured aerodynamic drag of the vehicle.

### EXAMPLE 1

### Braking on Wet Ground

These results were obtained by mounting the tire on a passenger vehicle and running it at a steady speed of 80 km/h. For each test, the vehicle is braked down to a speed of 20 km/h. The braking distance is measured. The vehicle comprises four identical tires. The control tire of reference 205/55 R 16 is inflated to 2.5 bar on a 6.5J16 rim, and the tire (1) according to the invention is inflated to 3.3 bar on a 5.5J16 rim. The results are given to base 100. Any values higher than 100 demonstrate an improvement by shortening the braking distance. The results are collated in table I below.

TABLE I

| | |
|---|---|
| Control | 100 |
| Tire according to the invention | 110 |

The rather rounded shape of the profile of the tire allows the pressure of the ground to be concentrated towards the centre of the contact patch. This makes it possible to optimize grip on wet ground.

### EXAMPLE 2

### Wear

These measurements were taken by mounting four identical tires on a passenger vehicle and running it over a predefined course. For each test, two vehicles ran the same course in parallel. Tests were carried out with tires (according to the invention) of dimension 165/70 R 16 inflated to a pressure of 3.3 bar, and with control tires of dimension 205/55 R 16 inflated to a pressure of 2.5 bar. Before and after wear, the tires were weighed and the depth of the tread patterns measured at regular intervals during the course of wearing. The results are collated in table II below.

TABLE II

| | | Tire according to the |
|---|---|---|
| | Control tire | invention |
| Loss of mass | 100 | 120 |

This table shows that the tire according to the invention allows a reduction in tread wear because it conserves its mass better.

### EXAMPLE 3

### Measurement of the Aerodynamic Drag of the Vehicle

These measurements were taken by mounting the tires on a passenger vehicle and running the vehicle on a rolling road while subjecting it to an airflow parallel to the vehicle at a speed of 120 km/h. The test involved measuring the aerodynamic drag of the tire. The control tire (reference 205/55 R 16) is inflated to 2.5 bar on a 6.5J16 rim, and the tire according to the invention (165/70 R 16) to 3.3 bar on a 5.5J16 rim. The results are collated in table III below.

TABLE III

| | | Tire according to the |
|---|---|---|
| | Control tire | invention |
| Aerodynamic drag | 100 | 103 |

This table shows that the aerodynamic drag of the tire according to the invention is improved.

### EXAMPLE 4

### Cornering Stiffness

The cornering stiffness measurements were obtained using a machine comprising a rolling belt able to withstand the transverse loadings experienced by the tire, as a function of the load.

These measurements are collated in table IV below.

| | | Tire according to the |
|---|---|---|
| | Control tire | invention |
| Cornering stiffness | 100 | 104 |

The tire according to the invention improves cornering stiffness by 4%.

1. A tire having an external perimeter, a tread arranged radially on the outside of a reinforcing belt of the tire, itself on the outside of a carcass reinforcement, said tread having an axial half-width L, a mean radial depth E, comprising a central median zone and two axially end zones, called shoulders of width L/2, and comprising a tread surface intended to come into contact with the ground, said tread comprising a plurality of transverse incisions and of circumferential incisions opening onto the surface of the tread, each circumferential and transverse incision having a mean radial depth E;
at least one circumferential incision having at the shoulder:
a mean circumferential radius of curvature of the shoulder R_{c},
a linear void ratio T_{c}, and
an axial width L_{c}, the said circumferential incisions being spaced by a length P from a radial axis ZZ′ passing through the centre of the tire; and
transverse incisions having at the shoulder:
a mean transverse radius of curvature of the shoulder Rₜ,
a linear void ratio Tₜ, and
an axial width Lₜ,
wherein the linear void ratio T_{c} is greater than or equal to 0.8 E/Rt and less than or equal to 1.2 E/Rt,
wherein the linear void ratio Tₜ is greater than or equal to 0.8 E/Rc and less than or equal to 1.2 E/Rc,
wherein T_{c}>Tₜ, and
wherein Lc is greater than or equal to 0.2 mm and less than or equal to 1.5 mm.

2. The tire according to claim 1, wherein T_{c} is greater than or equal to 0.85 E/Rₜ and less than or equal to 1.15 E/Rₜ and wherein Tₜ is greater than or equal to 0.85 E/R_{c} and less than or equal to 1.15 E/R_{c}.

3. The tire according to claim 1, wherein Tₜ is greater than or equal to 0.85 E/R_{c} and less than or equal to 1.15 E/R_{c} over at least 90% of the radially outer surface of the shoulder.

4. The tire according to claim 1, wherein at least one shoulder comprises two circumferential incisions each having a substantially identical width.

5. The tire according to claim 1, wherein the axially outermost circumferential incision is distant from the median radial axis ZZ′ by the half-width L.

6. The tire according to claim 1, wherein the axially innermost circumferential incision is distant from the median radial axis ZZ′ by a width Pa greater than or equal to 0.55 L and less than or equal to 0.7 L.

7. The tire according to claim 1, wherein when the tread comprises three axially aligned circumferential incisions, the central circumferential incision is distant from the median radial axis ZZ′ by a length P_{b} greater than or equal to 0.75 L and less than or equal to 0.9 L.

8. The tire according to claim 1, wherein the radial depth E in the median central zone is between 5 and 8 mm.

9. The tire according to claim 1, wherein the width Lt is greater than or equal to 0.2 mm and less than or equal to 4 mm.

10. The tire according to claim 1, wherein it comprises at least one circumferential incision centred on the median radial axis ZZ′.

11. The tire according to claim 10, wherein the width of the circumferential incision centred on the median radial axis ZZ′ has a width of between 6 and 10 mm.

12. The tire according to claim 1, wherein in the central median zone, the transverse linear void ratio Tₜ is greater than 0.85 E/R_{c} and 1.15 E/R_{c} over at least 90% of the radially outer surface of the said central zone.

13. The tire according to claim 1, wherein the tire is inflated to a nominal pressure in excess of 2.5 bar.

14. The tire according to claim 1, wherein the mean transverse radius of curvature Rₜ of the shoulder zone is greater than 0.75 L and less than 0.85 L and less than 150 mm.

15. The tire according to claim 1, wherein Tₜ is greater than or equal to 0.85 E/R_{c} and less than or equal to 1.15 E/R_{c} over at least 95% of the radially outer surface of the shoulder.

16. The tire according to claim 1, wherein in the central median zone, the transverse linear void ratio Tₜ is greater than 0.85 E/R_{c} and 1.15 E/R_{c} over at least 95% of the radially outer surface of the said central zone.

17. The tire according to claim 1, wherein the tire is inflated to a nominal pressure in excess of 3 bar and lower than 4 bar.

18. The tire according to claim 1, wherein the mean transverse radius of curvature Rₜ of the shoulder zone is greater than 0.85 L and less than L and less than 75 mm.
